(19) United States
(12) Patent Application Publication
(10) Pub. No.: US 2026/0125535 A1
(43) Pub. Date: May 7, 2026

(54) THERMALLY CONDUCTIVE CLAY COMPOSITION

(71) Applicant: MITSUBISHI MATERIALS CORPORATION, Tokyo (JP)

(72) Inventors: Shintaro Iida, Amagasaki-shi (JP); Keiko Ashida, Amagasaki-shi (JP)

(73) Assignee: MITSUBISHI MATERIALS CORPORATION, Tokyo (JP)

(21) Appl. No.: 19/118,545

(22) PCT Filed: Jan. 10, 2024
(86) PCT No.: PCT/JP2024/000230

§ 371 Date: Apr. 4, 2025

(30) Foreign Application Priority Data
Jan. 10, 2023 (JP) 2023-001565
Dec. 5, 2023 (JP) 2023-205643

(51) Int. Cl. C08K 3/22; C08G 18/69

(52) U.S. Cl. CPC C08K 3/22; C08G 18/69; C08K 2003/2227; C08K 2201/001; C08K 2201/003

(57) ABSTRACT

A thermally conductive clay composition contains a liquid polyol and an inorganic filler, in which the amount of the inorganic filler with respect to 100 parts by mass of the liquid polyol is within a range of 1,000 parts by mass or more and 3,300 parts by mass or less, and a tackiness index defined by an integral value of a region to which a tensile load is applied when a probe is pulled up in a tackiness tester is 10 g·s or greater.

### TECHNICAL FIELD

This invention relates to, for example, a thermally conductive clay composition that is disposed between a heat generating body and a heat dissipation member and efficiently transfers heat generated from the heat generating body to the heat dissipation member.

Priority is claimed on Japanese Patent Application No. 2023-001565, filed Jan. 10, 2023, and Japanese Patent Application No. 2023-205643, filed Dec. 5, 2023, the contents of which are incorporated herein by reference.

### BACKGROUND ART

In recent years, as the performance and integration of various electronic devices have been improved, there is a demand for a structure in which heat radiation has been increased so that heat generated along with the operation of a constituent component (heat generating body) can be efficiently dissipated to the outside using a heat dissipation member.

Thus, in order to reduce the thermal resistance between the heat generating body and the heat dissipation member, a heat transfer sheet may be disposed between the heat generating body and the heat dissipation member.

For example, Patent Document 1 proposes a polyurethane resin composition in which heat radiation is improved by mixing inorganic substances such as a ceramic powder, a metal powder, and a carbon material with a polyurethane, which is a base material, and a thermally conductive sheet made from this polyurethane resin composition.

Furthermore, Patent Document 2 proposes a fluorine-containing elastomer composition for a heat dissipation material, in which an insulating thermally conductive filler such as aluminum oxide is added to a fluorine-containing elastomer, which is a base material, to improve heat radiation, and a heat transfer sheet made from this fluorine-containing elastomer composition for a heat dissipation material.

### CITATION LIST

### Patent Documents

Patent Document 1: Japanese Unexamined Patent Application, First Publication No. 2010-248350(A)
Patent Document 2: Japanese Patent No. 6493616(B)

### SUMMARY OF INVENTION

### Technical Problem

Incidentally, with regard to the polyurethane resin composition and the thermally conductive sheet described in Patent Document 1, a polyurethane is synthesized by a urethane curing reaction in which a polyol and an isocyanate are crosslinked by a urethane bond. Here, the isocyanate used in the urethane curing reaction is toxic and difficult to handle. Furthermore, with regard to a sheet produced by a curing reaction, there is a risk that the shape followability is poor, the adhesiveness to the heat generating body and the heat dissipation member cannot be ensured, and the thermal resistance between the heat generating body and the heat dissipation member cannot be sufficiently reduced in a case where there is surface unevenness in either the heat generating body or the heat dissipation member, or the like.

Furthermore, the fluorine-containing elastomer composition for a heat dissipation material and the heat transfer sheet described in Patent Document 2 are flexible because they do not involve a curing reaction, and have excellent shape followability as compared with the thermally conductive sheet of Patent Document 1. However, the fluorine-containing elastomer is relatively expensive, and there is a problem that the production cost increases. Furthermore, the fluorine-containing elastomer has poor wettability with an inorganic substance, and there is a risk that voids may be generated inside the heat transfer sheet, which may result in a decrease in the thermal conduction properties.

This invention has been made in view of the above-described circumstances, and an object of the invention is to provide a thermally conductive clay composition which is clay-like and has particularly excellent shape followability, and which sufficiently contains an inorganic filler and therefore has particularly excellent thermal conduction properties.

### Solution to Problem

In order to solve the above-described problems, the inventors of the present invention conducted intensive studies, and as a result, they found that since liquid polyols have hydrophilic hydroxyl groups, liquid polyols have good wettability with inorganic fillers, and even when a large amount of the inorganic filler is contained, liquid polyols become clay-like, making it possible to ensure shape followability. Furthermore, the inventors found that shape followability can be ensured by evaluating the tackiness index using a tackiness tester.

The present invention has been made based on the above-described findings, and a thermally conductive clay composition of Aspect 1 of the present invention contains a liquid polyol and an inorganic filler, in which the amount of the inorganic filler with respect to 100 parts by mass of the liquid polyol is within a range of 1,000 parts by mass or more and 3,300 parts by mass or less, and a tackiness index defined by an integral value of a region to which a tensile load is applied when a probe is pulled up in a tackiness tester is 10 g·s or greater.

According to the thermally conductive clay composition of Aspect 1 of the present invention, since a liquid polyol and an inorganic filler are contained, and the amount of the inorganic filler with respect to 100 parts by mass of the liquid polyol is within the range of 1,000 parts by mass or more and 3,300 parts by mass or less, the thermally conductive clay composition is highly filled with the inorganic filler and has particularly excellent thermal conduction properties.

Furthermore, in a tackiness tester, since the tackiness index defined by the integral value of a region to which a tensile load is applied when the probe is pulled up is 10 g·s or greater, the shape followability is excellent, the adhesiveness to a heat generating body and a heat dissipation member can be ensured, and the thermal resistance between the heat generating body and the heat dissipation member can be sufficiently reduced.

A thermally conductive clay composition according to Aspect 2 of the present invention is such that, with regard to the thermally conductive clay composition according to Aspect 1 of the present invention, the liquid polyol is one or more kinds selected from the group consisting of a polybutadiene polyol, a polyester polyol, a polyisoprene polyol, and a polyolefin polyol.

According to the thermally conductive clay composition of Aspect 2 of the present invention, since the liquid polyol is one or more kinds selected from the group consisting of a polybutadiene polyol, a polyester polyol, a polyisoprene polyol, and a polyolefin polyol, the thermally conductive clay composition has excellent wettability with an inorganic filler, can reliably contain a large amount of an inorganic filler, and has particularly excellent thermal conduction properties.

A thermally conductive clay composition according to Aspect 3 of the present invention is such that, with regard to the thermally conductive clay composition according to Aspect 1 or Aspect 2 of the present invention, the inorganic filler is one or more kinds selected from the group consisting of aluminum oxide, aluminum nitride, boron nitride, silicon nitride, silicon carbide, magnesium oxide, and zinc oxide.

According to the thermally conductive clay composition of Aspect 3 of the present invention, since the inorganic filler is one or more kinds selected from the group consisting of aluminum oxide, aluminum nitride, boron nitride, silicon nitride, silicon carbide, magnesium oxide, and zinc oxide, the thermally conductive clay composition has excellent thermal conduction properties and insulating properties and is particularly suitable for use applications that require insulating properties.

A thermally conductive clay composition according to Aspect 4 of the present invention is such that, with regard to the thermally conductive clay composition according to any one of Aspect 1 to Aspect 3 of the present invention, an average particle diameter of the inorganic filler is within a range of 0.1 μm or more and 200 μm or less.

According to the thermally conductive clay composition of Aspect 4 of the present invention, since the average particle diameter of the inorganic filler is within the range of 0.1 μm or more and 200 μm or less, it is possible to disperse the inorganic filler relatively uniformly, and the composition can be prevented from becoming hard even when highly filled.

### Advantageous Effects of Invention

According to the present invention, a thermally conductive clay composition which is clay-like and has particularly excellent shape followability, and which sufficiently contains an inorganic filler and therefore has particularly excellent thermal conduction properties.

### BRIEF DESCRIPTION OF DRAWINGS

FIG. 1 A schematic explanatory view showing a method for evaluating the tackiness index of a thermally conductive clay composition according to an embodiment of the present invention.

FIG. 2A A schematic explanatory view showing a method for evaluating the adhesiveness of the thermally conductive clay composition according to the embodiment of the present invention.

FIG. 2B A schematic explanatory view showing a method for evaluating the adhesiveness of the thermally conductive clay composition according to the embodiment of the present invention. An arrow in the vertical direction on the paper surface indicates the pulling in the vertical direction when pulling a test object up and down with a tensile tester to measure the adhesive strength and elongation.

### DESCRIPTION OF EMBODIMENTS

Hereinafter, a thermally conductive clay composition according to an embodiment of the present invention will be described with reference to the attached drawings. Each embodiment described below is specifically described for better understanding of the gist of the invention, and does not limit the present invention unless particularly stated otherwise.

The thermally conductive clay composition according to the embodiment of the present invention is, for example, disposed between a heat generating body and a heat dissipation member and transfers heat generated from the heat generating body to the heat dissipation member.

The thermally conductive clay composition according to the present embodiment is considered to contain a liquid polyol and an inorganic filler, and the amount of the inorganic filler with respect to 100 parts by mass of the liquid polyol is within the range of 1,000 parts by mass or more and 3,300 parts by mass or less.

With regard to the thermally conductive clay composition according to the present embodiment, the tackiness index defined by the integral value of a region to which a tensile load is applied when the probe is pulled up in the tackiness tester, is 10 g·s or greater.

Here, in a case where the amount of the inorganic filler with respect to 100 parts by mass of the liquid polyol is less than 1,000 parts by mass, there is a risk that the thermal conduction properties may not be ensured because the inorganic filler is not sufficiently contained.

On the other hand, in a case where the amount of the inorganic filler with respect to 100 parts by mass of the liquid polyol exceeds 3,300 parts by mass, there is a risk that the thermally conductive clay composition may become hard, and the shape followability may be insufficient.

The lower limit of the amount of the inorganic filler with respect to 100 parts by mass of the liquid polyol is preferably 1,200 parts by mass or more, and more preferably 1,500 parts by mass or more. On the other hand, the upper limit of the amount of the inorganic filler with respect to 100 parts by mass of the liquid polyol is preferably 3,000 parts by mass or less, and more preferably 2,800 parts by mass or less.

Furthermore, the mass proportion of the filler in the thermally conductive clay composition is, for example, 90% by mass or more and 97% by mass or less. The thermal conductivity of the thermally conductive clay composition may be about 3.5 to 10 W/(m·K).

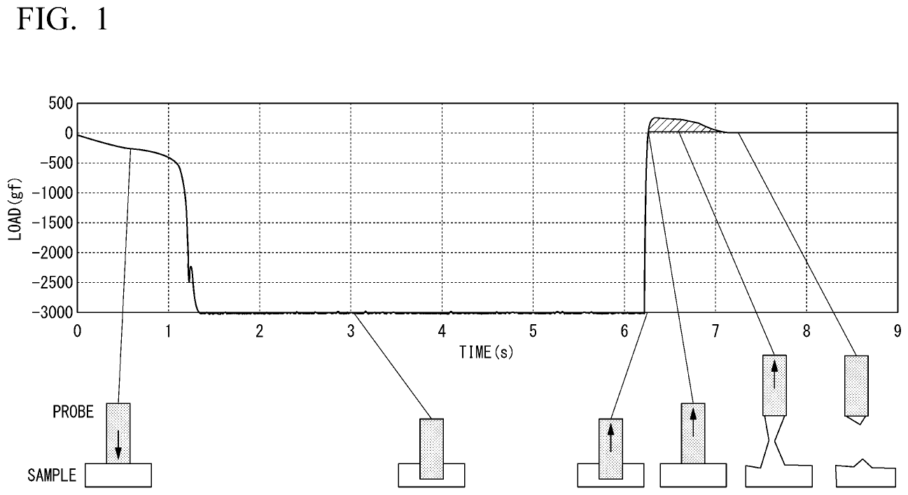

Next, a method for evaluating the tackiness index of the thermally conductive clay composition according to the present embodiment will be described with reference to the attached FIG. 1.

The tackiness tester for evaluating the tackiness index includes a stage on which the thermally conductive clay composition (PASTE) is placed, a probe (PROBE) that moves up and down with respect to the stage, and load measuring means for measuring the load applied to the probe.

First, the probe is lowered, and the probe is brought close to and brought into contact with the thermally conductive clay composition placed on the stage.

In addition, the probe is further lowered and pushed to crush the thermally conductive clay composition. The thermally conductive clay composition is held in this state for a certain period of time. In this case, as shown in FIG. 1, a compressive load is applied to the probe.

Next, the probe is raised and pulled up. Then, as shown in FIG. 1, the thermally conductive clay composition is pulled up in a state of adhering to the probe. As a result, a tensile load is applied to the probe.

Then, when the probe is further raised, the thermally conductive clay composition is separated from the probe, and the load on the probe is no longer applied.

Here, as shown in FIG. 1, the integral value of a region to which the tensile load was applied when the probe was pulled up was defined as the “tackiness index”. When this tackiness index is high, the thermally conductive clay composition easily adheres to the probe, and the shape followability is excellent.

With regard to the thermally conductive clay composition according to the present embodiment, since the above-described tackiness index is set to 10 g·s or more, the shape followability is sufficiently excellent.

The tackiness index of the thermally conductive clay composition is preferably 30 g·s or greater, and more preferably 50 g·s or greater. On the other hand, the upper limit of the tackiness index of the thermally conductive clay composition is not particularly limited; however, in order to suppress stickiness and facilitate handling, it is preferably set to 1,000 g·s or less, and more preferably set to 500 g·s or less.

The liquid polyol is a polyol that is in a liquid state at normal temperature (25° C.) and has hydrophilic hydroxyl groups (—OH). For this reason, the affinity with the inorganic filler is excellent, and the inorganic filler can be highly filled as compared with other liquid polymers. Therefore, it is possible to significantly improve the thermal conduction properties. Furthermore, the generation of voids around the inorganic filler can be suppressed.

Here, in the present embodiment, it is preferable to use one or more kinds selected from the group consisting of a polybutadiene polyol, a polyester polyol, a polyisoprene polyol, and a polyolefin polyol as the liquid polyol.

The inorganic filler is made of an inorganic substance such as ceramics or metal, and is composed of a material having more excellent thermal conduction properties than the liquid polyol.

With regard to the thermally conductive clay composition according to the present embodiment, when insulating properties are required, it is preferable to use one or more kinds selected from the group consisting of aluminum oxide, aluminum nitride, boron nitride, silicon nitride, silicon carbide, magnesium oxide, and zinc oxide, as the inorganic filler.

On the other hand, with regard to the thermally conductive clay composition according to the present embodiment, in a case where insulating properties are not required, it is preferable to use a metal powder having excellent thermal conduction properties.

Furthermore, it is preferable that the average particle diameter of the inorganic filler is within the range of 0.1 μm or more and 200 μm or less.

By setting the average particle diameter of the inorganic filler to 0.1 μm or more, the thermally conductive clay composition can be suppressed from becoming hard even when a large amount of the inorganic filler is contained, the inorganic filler can be reliably highly filled, and it is possible to further improve the thermal conduction properties.

On the other hand, by setting the average particle diameter of the inorganic filler to 200 μm or less, the inorganic filler can be more uniformly dispersed.

The lower limit of the average particle diameter of the inorganic filler is more preferably 0.5 μm or more, and even more preferably 1 μm or more. On the other hand, the upper limit of the average particle diameter of the inorganic filler is more preferably 150 μm or less, and still more preferably 100 μm or less.

Furthermore, as the liquid polyol used in the present embodiment is crosslinked with an isocyanate through a urethane bond (urethane curing reaction), a polyurethane is synthesized. In a case where a large amount of a polyurethane is synthesized, the tackiness index is decreased significantly, becoming less than 10 g·s. For this reason, when an isocyanate is contained, it is necessary to limit the amount of the isocyanate to such an amount that a urethane curing reaction with the liquid polyol occurs only slightly. That is, it is preferable that the thermally conductive clay composition according to the present embodiment does not contain any substance that undergoes a crosslinking reaction with the liquid polyol, and in a case where the thermally conductive clay composition contains a substance that undergoes a crosslinking reaction with the liquid polyol, it is preferable that the tackiness index of the thermally conductive clay composition is about 10 g·s or greater.

The thermally conductive clay composition according to the present embodiment is produced by weighing the above-described liquid polyol and inorganic filler in predetermined proportions, and mixing and kneading these components. The kneading means is not particularly limited, and existing techniques such as a rotation-revolution mixer, a two-roll, and a kneader can be appropriately selected and applied.

Here, in order to efficiently achieve high filling of the inorganic filler, the viscosity of the liquid polyol before kneading is preferably set to 10 Pa·s or less, and more preferably set to 6 Pa·s or less. The lower limit of the viscosity of the liquid polyol before kneading is not particularly limited; however, the lower limit is substantially 0.1 Pa·s or greater.

Furthermore, the viscosity of the thermally conductive clay composition after mixing and kneading the above-described liquid polyol and inorganic filler is desirably about 500 Pa·s or greater and 100,000 Pa·s or less, and more desirably 1,500 Pa·s or greater and 50,000 Pa·s or less.

Since the thermally conductive clay composition according to the present embodiment configured as described above contains a liquid polyol having hydroxyl groups and an inorganic filler, and the amount of the inorganic filler with respect to 100 parts by mass of the liquid polyol is 1,000 parts by mass or more, the inorganic filler is highly filled, and the thermal conduction properties are particularly excellent. Furthermore, since the amount of the inorganic filler with respect to 100 parts by mass of the liquid polyol is 3,300 parts by mass or less, the thermally conductive clay composition exhibits sufficient shape followability without becoming hard.

With regard to the thermally conductive clay composition according to the present embodiment, since the tackiness index defined by the integral value of a region to which a tensile load is applied in a tackiness tester when the probe is pulled up is 10 g·s or greater, the shape followability is sufficiently excellent, the adhesiveness to the heat generating body and the heat dissipation member can be ensured, and the thermal resistance between the heat generating body and the heat dissipation member can be sufficiently reduced.

Here, with regard to the thermally conductive clay composition according to the present embodiment, in a case where the liquid polyol is one or more kinds selected from the group consisting of a polybutadiene polyol, a polyester polyol, a polyisoprene polyol, and a polyolefin polyol, the wettability with the inorganic filler is sufficiently excellent, a large amount of the inorganic filler can be reliably contained, and the thermal conduction properties are particularly excellent. Furthermore, the generation of voids around the inorganic filler can be suppressed.

Furthermore, with regard to the thermally conductive clay composition according to the present embodiment, in a case where the inorganic filler is one or more kinds selected from the group consisting of aluminum oxide, aluminum nitride, boron nitride, silicon nitride, silicon carbide, magnesium oxide, and zinc oxide, the thermal conduction properties and the insulating properties are excellent, and the thermally conductive clay composition is particularly suitable for use applications where insulating properties are required.

In addition, with regard to the thermally conductive clay composition according to the present embodiment, in a case where the average particle diameter of the inorganic filler is within the range of 0.1 μm or more and 200 μm or less, it is possible to disperse the inorganic filler relatively uniformly, and the composition can be suppressed from becoming hard even when the inorganic filler is highly filled.

Hereinabove, the embodiments of the present invention have been described; however, the present invention is not limited thereto and can be suitably modified to the extent that does not depart from the technical idea of the invention.

In the present embodiment, the thermally conductive clay composition has been described as a composition disposed between a heat generating body and a heat dissipation member; however, the thermally conductive clay composition is not limited thereto, and may be used for other use applications.

### EXAMPLES

Verification experiments performed to verify the effectiveness of the present invention will be described.

As shown in Table 1, a liquid polyol and an inorganic filler were each weighed and mixed together. The mixture was kneaded and then molded into a sheet having a thickness of 2 mm to obtain a specimen for evaluation.

First, a sample having a size of 20 mm on each side of a square×a thickness of 2 mm was collected from the specimen for evaluation, the sample was compressed by 50% in the thickness direction using a texture analyzer (manufactured by IMADA, Inc.), the thickness restoration rate after the compression was released after a lapse of 100 minutes was measured, and in a case where the thickness restoration rate was less than 50%, the sample was determined to be “clay-like”. The thickness restoration rate is (thickness after restoration—thickness during compression)/(thickness before compression—thickness during compression). For example, in a case where a sample having a thickness of 2 mm is compressed by 50% to 1 mm, compression is released, and then the sample is restored to 1.1 mm, the thickness restoration rate is (1.1-1)/(2-1)=10%. The evaluation results are shown in Table 1.

Next, the tackiness index was evaluated using a tackiness tester (TAC1000 manufactured by RHESCA Co., Ltd.). First, a sample was molded to have a size of 20 mm on each side of a square×a thickness of 2 mm. The sample was installed in a tester, a probe was pressed against the specimen for evaluation at a pressing speed of 2 mm/s using a probe made of SIUS and having a diameter of 5 mmφ until the load reached—3,000 gf, and the probe was held for 5 seconds. Thereafter, the probe was pulled up from the holding point to a height of 5 mm at a pulling speed of 1 mm/s.

In this case, a change in the load applied to the probe was graphed with the load on the axis of ordinate and the time on the axis of abscissa, and the integral value of a region to which a tensile load was applied (that is, a region where the load was positive) was determined and defined as the tackiness index. The evaluation results are shown in Table 1.

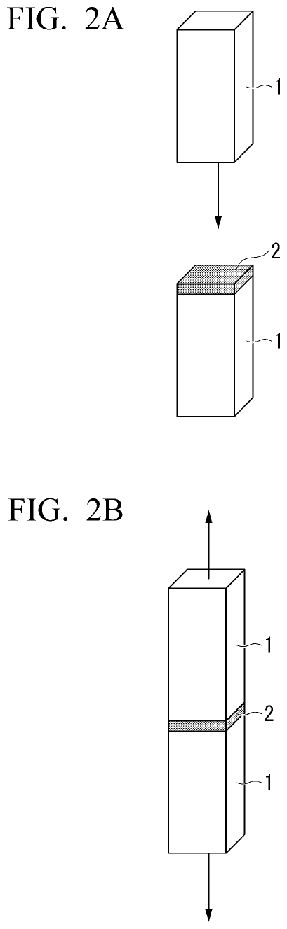

Regarding the adhesiveness, as shown in FIG. 2, two aluminum rods were prepared, each sample was sandwiched and pressed between the two aluminum rods, and then the sample that protruded due to pressing was removed to produce a test piece in which a molded sample (25 mm in length×19 mm in width×1 mm in thickness) was sandwiched between two aluminum rods. Then, using a tensile tester (AGS-X: manufactured by Shimadzu Corporation), the aluminum rods of the test piece were pulled at a tensile rate of 50 mm/min to measure the adhesive strength and the elongation, and based on these values, the maximum stress of each specimen was calculated as the adhesiveness.

A sample was molded to have a size of 10 mm on each side of a square×a thickness of 2 mm, and the thermal conductivity was measured using a resin material thermal resistance measuring device (PCM series: manufactured by Hitachi Technologies and Services, Ltd.). Measurement was carried out under conditions in which the measurement load in the constant thickness mode was within the range of 0.1 to 1 N.

TABLE 1

| | | | | | | Thickness | | | |
|---|---|---|---|---|---|---|---|---|---|
| | | Liquid polyol | | Inorganic filler | | restoration | Tackiness | Thermal | |
| | | | Parts by | | Parts by | rate | index | conductivity | Adhesiveness |
| | | Material | mass | Material | mass | % | gf's | W/(m · K) | MPa |
| Invention | 1 | Polybutadiene polyol | 100 | Alumina | 1000 | 10.00 | 470.0 | 3.5 | 0.12 |
| Example | 2 | Polybutadiene polyol | 100 | Alumina | 1800 | 5.00 | 84.0 | 5.4 | 0.08 |
| | 3 | Polybutadiene polyol | 100 | Alumina | 2600 | 2.00 | 32.0 | 4.7 | 0.05 |
| | 4 | Polyester polyol | 100 | Alumina | 1000 | 8.00 | 176.0 | 3.6 | 0.10 |
| | 5 | Polyester polyol | 100 | Alumina | 3300 | 2.00 | 10.0 | 9.0 | 0.03 |
| Comparative | 1 | Polyester polyol | 100 | Alumina | 900 | 8.00 | 150.0 | 3.0 | 0.09 |
| Example | 2 | Polyester polyol | 100 | Alumina | 3400 | 1.00 | 4.5 | 8.9 | 0.01 |

In Comparative Example 1, the amount of the inorganic filler with respect to 100 parts by mass of the liquid polyol was set to 900 parts by mass, and the thermal conductivity was as low as 3.0 W/(m·K).

In Comparative Example 2, the amount of the inorganic filler with respect to 100 parts by mass of the liquid polyol was set to 3,400 parts by mass, the tackiness index was 4.5 g·s, the shape followability was poor, and the adhesiveness was 0.01 MPa, which was poor. Furthermore, in general, it is assumed that when the content of the inorganic filler is increased, the thermal conductivity is increased; however, in Comparative Example 2, even though the number of parts by mass of the inorganic filler was larger than that of Example 5 of the present invention, the thermal conductivity was low because the shape followability and the adhesiveness were poor.

In contrast, in Examples 1 to 5 of the present invention, the amount of the inorganic filler with respect to 100 parts by mass of the liquid polyol was within the range of 1,000 parts by mass or more and 3,300 parts by mass or less, the tackiness index was 10 g·s or greater, the shape followability was excellent, and the adhesiveness was 0.03 MPa or greater, which was excellent. Furthermore, the thermal conductivity was 3.5 W/(m·K) or greater, and the thermal conduction properties were excellent.

As described above, according to the present invention, it has been verified that it is possible to provide a thermally conductive clay composition which is clay-like and has particularly excellent shape followability, and which sufficiently contains an inorganic filler and has particularly excellent thermal conduction properties.

### INDUSTRIAL APPLICABILITY

A thermally conductive clay composition which is clay-like and has particularly excellent shape followability, and which sufficiently contains an inorganic filler and has particularly excellent thermal conduction properties, can be provided.

### REFERENCE SIGNS LIST

1 Al rod
2 Sample (25×19×1 mmt)

1. A thermally conductive clay composition comprising: a liquid polyol; and an inorganic filler, wherein an amount of the inorganic filler with respect to 100 parts by mass of the liquid polyol is within a range of 1,000 parts by mass or more and 3,300 parts by mass or less, and
a tackiness index defined by an integral value of a region to which a tensile load is applied when a probe is pulled up in a tackiness tester is 10 g s or greater.

2. The thermally conductive clay composition according to claim 1, wherein the liquid polyol is one or more kinds selected from the group consisting of a polybutadiene polyol, a polyester polyol, a polyisoprene polyol, and a polyolefin polyol.

3. The thermally conductive clay composition according to claim 1, wherein the inorganic filler is one or more kinds selected from the group consisting of aluminum oxide, aluminum nitride, boron nitride, silicon nitride, silicon carbide, magnesium oxide, and zinc oxide.

4. The thermally conductive clay composition according to claim 1, wherein an average particle diameter of the inorganic filler is within a range of 0.1 μm or more and 200 μm or less.
